(19) United States
(12) Patent Application Publication
(10) Pub. No.: US 2013/0298605 A1
(43) Pub. Date: Nov. 14, 2013

(54) Silicon Carbide Asscher Cut Gemstone

(71) Applicant: Anthony Ritchie, Kent, WA (US)

(72) Inventor: Anthony Ritchie, Kent, WA (US)

(21) Appl. No.: 13/467,037

(22) Filed: May 8, 2012

(51) Int. Cl. A44C 17/00; B28D 5/00

(52) U.S. Cl. 63/32; 125/30.01

(57) ABSTRACT

The instant application discloses, among other things, a specific set of cutting proportions tailored for the optical characteristics of Silicon Carbide (“SiC”) Asscher cut gemstone.

### FIELD

This disclosure relates to a way to produce a Silicon Carbide Asscher Cut gemstone.

### BACKGROUND

Generally, facets on precious and semi-precious gemstones are cut so as to provide brilliance to these gemstones in an economical manner. Gemstones may also be cut to provide reflections with patterns visible.

### SUMMARY OF THE INVENTION

The instant application discloses, among other things, a specific set of cutting proportions tailored for the optical characteristics of Silicon Carbide (“SiC”) Princess cut gemstone.

Silicon Carbide (SiC) is a compound of silicon and carbon. It exists in a number of crystalline forms, often grouped as polytypes of similar structures. Three common polytypes are 3C (β), 4H, and 6H (α). 3C (β) has a cubic crystal structure; 4H and 6H (α) each have hexagonal crystal structures.

### BRIEF DESCRIPTION OF THE DRAWINGS

FIG. 1 is a side view of an example of an SiC Asscher Cut gemstone.

FIG. 2 is a top view of an example of an SiC Asscher Cut gemstone.

FIG. 3 is a bottom view of an example of SiC Asscher Cut gemstone.

FIG. 4 is an illustration of a flowchart of one way to create an SiC Asscher Cut gemstone.

### DESCRIPTION OF THE INVENTION

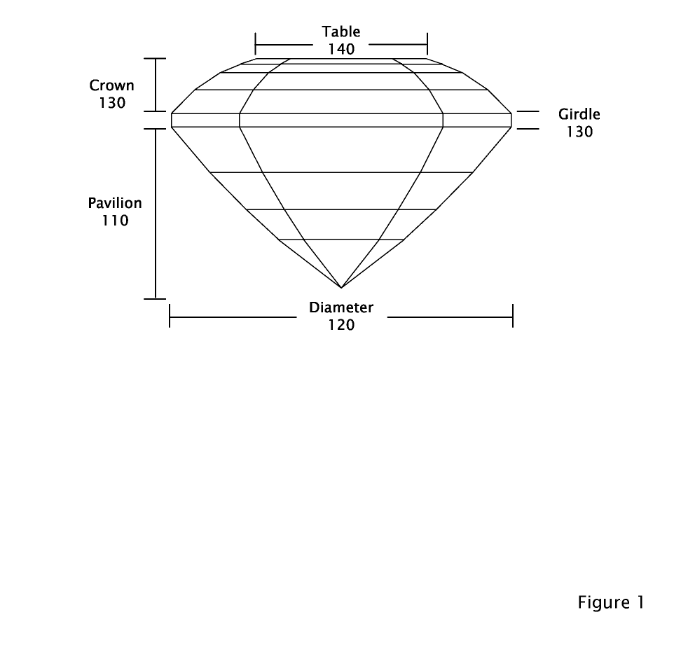

FIG. 1 is a side view of an example of an SiC Asscher cut gemstone. Crown 130 is the portion of a gem above the girdle. Girdle 130 is the outer edge of the gemstone, separating the Crown 100 and the Pavilion 110. Girdle 130 is generally located near the area of a gemstone at the widest portion of the gemstone, where Diameter 120 indicates the edge-to-edge width of the gemstone. Table 140 is the largest facet on the gemstone.

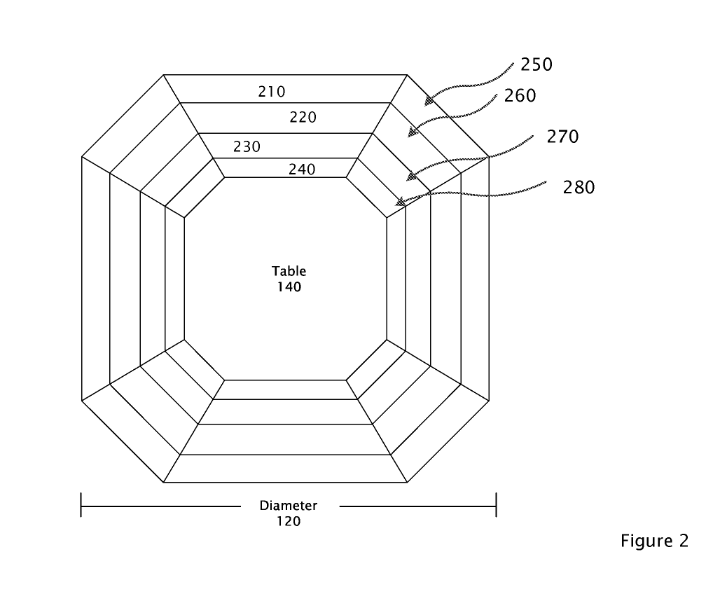

FIG. 2 is a top view (Crown side) of an example of an SiC Asscher Cut gemstone. The SiC gemstone has a four-fold symmetry. The angles for this cut may be:

| Facet | Degrees |
|---|---|
| Crown Main Tier One Facets 210 | 45.4 |
| Crown Main Tier Two Facets 220 | 34.3 |
| Crown Main Tier Three Facets 230 | 22.6 |
| Crown Main Tier Four Facets 240 | 18.5 |
| Crown Corner Tier One Facets 250 | 41.8 |
| Crown Corner Tier Two Facets 260 | 31.1 |
| Crown Corner Tier Three Facets 270 | 20.2 |
| Crown Corner Tier Four Facets 280 | 16.5 |

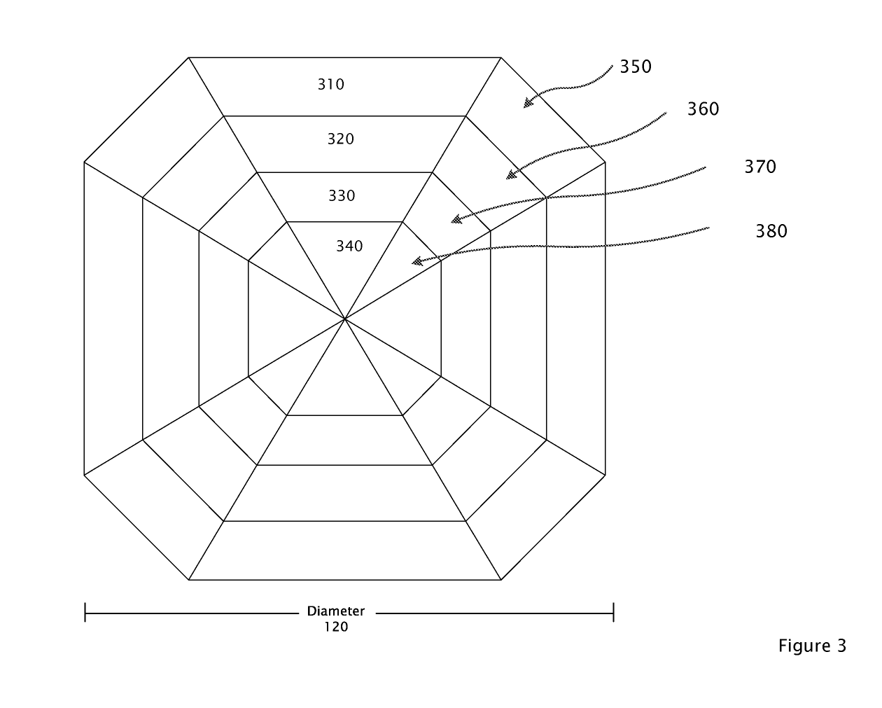

FIG. 3 is a bottom view (Pavilion side) of an example of an SiC Asscher cut gemstone. The cuts may be made in several tiers.

The angles for this cut may be:

| Facet | Degrees |
|---|---|
| Pavilion Main Tier One Facets 310 | 49.8 |
| Pavilion Main Tier Two Facets 320 | 45.1 |
| Pavilion Main Tier Three Facets 330 | 43.1 |
| Pavilion Main Tier Four Facets 340 | 37.6 |
| Pavilion Corner Tier One Facets 350 | 46.3 |
| Pavilion Corner Tier Two Facets 360 | 41.6 |
| Pavilion Corner Tier Three Facets 370 | 39.6 |
| Pavilion Corner Tier Four Facets 380 | 34.3 |

One having skill in the art will recognize that slight variations in the cutting angle, up to approximately 0.2 degrees greater or smaller, may still produce a desired Asscher cut SiC gem.

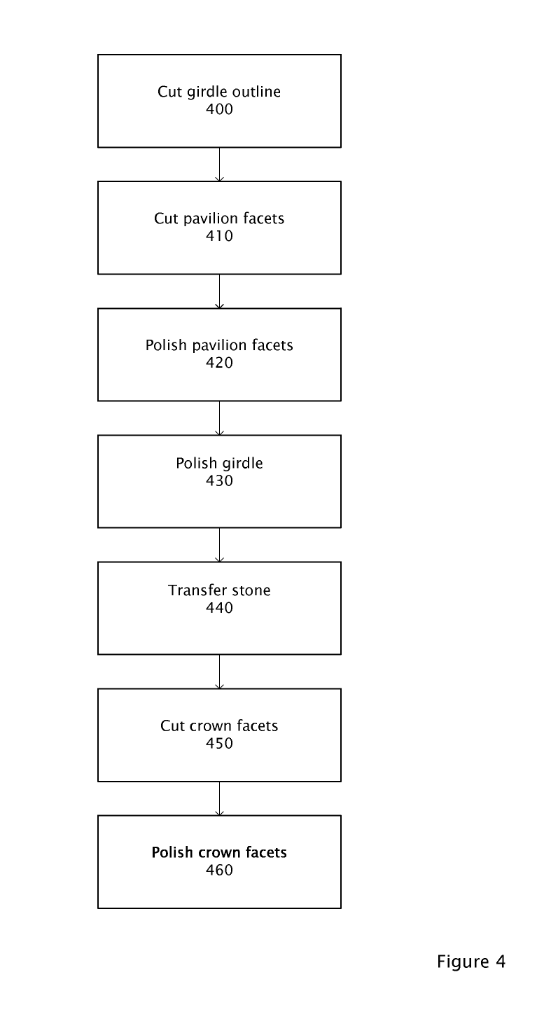

FIG. 4 is an illustration of a flowchart of one way to create a Asscher cut gemstone. In this example, a girdle outline is cut 400 to provide a diameter of the SiC gemstone. The pavilion facets are cut 410, including pavilion main facets and pavilion corner facets.

The pavilion facets are polished 420, as is the girdle 430. The stone is transferred to allow cutting and polishing of the crown side.

The crown main and corner facets are cut 450, and polished 460.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. An SiC gemstone, comprising:
a crown portion comprising:
a plurality of crown main tier one facets cut at an angle of approximately 45.4 degrees;
a plurality of crown main tier two facets cut at an angle of approximately 34.3 degrees;
a plurality of crown main facets tier three cut at an angle of approximately 22.6 degrees;
a plurality of crown main tier four facets cut at an angle of approximately 18.5 degrees;
a plurality of crown corner tier one facets cut at an angle of approximately 41.8 degrees;
a plurality of crown corner tier two facets cut at an angle of approximately 31.1 degrees;
a plurality of crown corner tier three facets cut at an angle of approximately 20.2 degrees;
a plurality of crown corner tier four facets cut at an angle of approximately 16.5 degrees;
a pavilion portion comprising:
a plurality of pavilion tier one facets cut at an angle of approximately 45.1 degrees;
a plurality of pavilion tier two facets cut at an angle of approximately 43.1 degrees;
a plurality of pavilion tier three facets cut at an angle of approximately 37.6 degrees;
a plurality of pavilion tier four facets cut at an angle of approximately 46.3 degrees;
a plurality of pavilion corner tier one facets cut at an angle of approximately 46.3 degrees;
a plurality of pavilion corner tier two facets cut at an angle of approximately 41.6 degrees;
a plurality of pavilion corner tier three facets cut at an angle of approximately 39.6 degrees;
a plurality of pavilion corner tier four facets cut at an angle of approximately 34.3 degrees;
a girdle portion abutting the crown portion and extending along a predetermined plane.

2. The SiC gemstone of claim 1 wherein there are four crown main tier one facets.

3. The SiC gemstone of claim 1 wherein there are four crown corner tier one facets.

4. The SiC gemstone of claim 1 wherein there are four crown main tier two facets.

5. The SiC gemstone of claim 1 wherein there are four crown corner tier two facets.

6. The SiC gemstone of claim 1 wherein there are four pavilion tier one facets.

7. The SiC gemstone of claim 1 wherein there are four pavilion tier two facets.

8. The SiC gemstone of claim 1 wherein there are four pavilion corner tier one facets.

9. The SiC gemstone of claim 1 wherein there are four pavilion corner tier two facets.

10. The SiC gemstone of claim 1 wherein there are four pavilion tier three facets.

11. The SiC gemstone of claim 1 wherein the SiC is selected from a group comprising 6H, 4H, and 3C SiC.

12. A method of cutting an SiC gemstone, comprising:
cutting a girdle outline of the SiC gemstone;
cutting a main tier one facet on a pavilion side of the SiC gemstone at an angle of approximately 49.8 degrees;
cutting a main tier two facet on the pavilion side of the SiC gemstone at an angle of approximately 45.1 degrees;
cutting a main tier three facet on the pavilion side of the SiC gemstone at an angle of approximately 43.1 degrees;
cutting a main tier four facet on the pavilion side of the SiC gemstone at an angle of approximately 37.6 degrees;
cutting a corner tier one facet on the pavilion side of the SiC gemstone at an angle of approximately 46.3 degrees;
cutting a corner tier two facet on the pavilion side of the SiC gemstone at an angle of approximately 41.6 degrees;
cutting a corner tier three facet on the pavilion side of the SiC gemstone at an angle of approximately 39.6 degrees;
cutting a corner tier four facet on the pavilion side of the SiC gemstone at an angle of approximately 34.3 degrees;
cutting a main tier one facet on the crown side of the SiC gemstone at an angle of approximately 45.4 degrees;
cutting a main tier two facet on the crown side of the SiC gemstone at an angle of approximately 34.3 degrees;
cutting a main tier three facet on the crown side of the SiC gemstone at an angle of approximately 22.6 degrees;
cutting a main tier four facet on the crown side of the SiC gemstone at an angle of approximately 18.5 degrees;
cutting a corner tier one facet on the crown side of the SiC gemstone at an angle of approximately 41.8 degrees;
cutting a corner tier two facet on the crown side of the SiC gemstone at an angle of approximately 31.1 degrees;
cutting a corner tier three facet on the crown side of the SiC gemstone at an angle of approximately 20.2 degrees; and
cutting a corner tier four facet on the crown side of the SiC gemstone at an angle of approximately 16.5 degrees;

13. The method of claim 12 wherein the cutting is performed by a robotic cutting machine.

14. The method of claim 12 further comprising polishing the facets on the crown side of the SiC gemstone.

15. The method of claim 12 further comprising polishing the facets on the pavilion side of the SiC gemstone.
